(19) United States
(12) Patent Application Publication
(10) Pub. No.: US 2011/0261961 A1
(43) Pub. Date: Oct. 27, 2011

(54) REDUCTION IN BEARER SETUP TIME

(75) Inventors: Dinesh Dharmaraju, San Diego, CA (US); Adrian Edward Escott, Reading (GB); Swaminathan Sureshchandran, San Diego, CA (US); Vanitha Aravadmudhan Kumar, San Diego, CA (US); Masato Kitazoe, Tokyo (JP); Rekha S. Iyer, San Diego, CA (US)

(73) Assignee: QUALCOMM Incorporated, San Diego, CA (US)

(21) Appl. No.: 13/091,783

(22) Filed: Apr. 21, 2011

Related U.S. Application Data
(60) Provisional application No. 61/327,034, filed on Apr. 22, 2010.

(51) Int. Cl. H04W 12/04; H04L 9/14

(52) U.S. Cl. 380/277

(57) ABSTRACT

A method and apparatus are provided for reducing latency and/or delays in performing a security activation exchange between a communication device and a network entity. The communication device may pre-compute a plurality of possible keys using a base key and a plurality of possible inputs in anticipation of receiving an indicator from the network entity that identifies a selected input to be used in generating a corresponding selected key. An indicator is then received from the network entity, where the indicator identifies the selected input from among the plurality of possible inputs. The communication device then selects a first key among the pre-computed plurality of possible keys as the selected key upon receipt of the indicator, wherein the first key is selected because it was pre-computed using the selected input. Because the first key is pre-computed, delays in responding to the network entity are reduced.

### CLAIM OF PRIORITY UNDER 35 U.S.C. §119

The present application for patent claims priority to U.S. Provisional Application No. 61/327,034 entitled “Reduction In Bearer Setup Time”, filed Apr. 22, 2010, and assigned to the assignee hereof and hereby expressly incorporated by reference herein.

### BACKGROUND

1. Field

Various features pertain to reducing setup time for a wireless and/or mobile communication device to establish communication services with a serving network.

2. Background

In wireless and/or mobile communication systems, security of over-the-air communications is typically a significant consideration. This includes security in establishing wireless service between a mobile communication device and a serving network as well as security of content and/or data transmitted by specific applications. In such wireless and/or mobile communication systems, a serving network typically provides wireless access and service to one or more mobile communication devices. Prior to providing full access to communication resources, the serving network may authenticate a mobile communication device (i.e., to verify a service subscription) and also establish one or more keys (e.g., for different purposes, applications, and/or services, associated with different levels of a communication protocol stack, as part of registration, etc.) to secure services, communications, and/or access to transmissions. There is typically a delay associated with the establishment of the one or more keys.

There is an ongoing goal to improve mobile communication device performance. One way to achieve such goal is to reduce the access time to communication services, thereby making the user experience as seamless as possible (i.e., reducing noticeable delays). However, security configuration is an initial step in setting up a logical bearer or channel (e.g., a communication link between a mobile communication device and a network entity or access node) in Long Term Evolution (LTE) networks. As part of this security configuration, key derivations and establishment take up a significant portion of time associated with the security activation process. Of these, most of the keys generated are ciphering and integrity keys for Non-Access Stratum (NAS) Security Mode Configuration (NAS SMC) and Access Stratum (AS) Security mode Configuration (AS SMC).

Therefore, if the time for dynamically generating the ciphering and/or integrity keys can be reduced, this may save bearer setup time and, consequently, improve the user experience.

### SUMMARY

A method operational in a communication device is provided for pre-computing one or more keys in anticipation of using a subset of such keys for communications over a network. The communication device may perform a security activation exchange with a network entity to acquire service via a wireless network. As part of such security activation exchange, the communication device may establish a base key with the network entity upon the occurrence of a triggering event (e.g., the receipt of a message from the network entity). The communication device may then pre-compute a plurality of possible keys using the base key and a plurality of possible inputs in anticipation of receiving an indicator from a network entity that identifies a selected input to be used in generating a corresponding selected key. The plurality of possible inputs may include algorithms with which to calculate security keys. During the pre-computation of the plurality of possible keys, the selected input is unknown to the communication device.

Subsequently, an indicator may be received from the network entity indicating the selected input from among the plurality of possible inputs. The communication device then selects a first key among the pre-computed plurality of possible keys as the selected key upon receipt of the indicator, wherein the first key is selected because it was pre-computed using the selected input. The selected key may then be utilized for one or more communications with the network entity.

According to one aspect, the communication device may reduce all available possible inputs to a selected plurality of possible inputs. It then utilizes the selected plurality of possible inputs to pre-compute the plurality of possible keys. Reducing all available possible inputs to a selected plurality of possible inputs may include selecting the most probable inputs based on a history of previously selected inputs. The pre-computed plurality of possible keys are limited by the number of security keys that can be calculated during a time interval between sending an uplink message and receiving a downlink message for the security activation exchange.

According to another feature, the communication device may predicatively select the plurality of possible inputs from a finite set of inputs, known to the communication device, based on which inputs are most likely to be received from the network entity.

In one implementation, the security activation exchange may be used to generate the first key which is a key within an Enhanced Universal Mobile Telecommunications Service (UMTS) Terrestrial Radio Access Network (E-UTRAN) key hierarchy. The plurality of possible keys may include Non-Access Stratum security keys and Access Stratum security keys used by Long Term Evolution compatible networks. In one example, a plurality of possible inputs selected for pre-computing the Non-Access Stratum security keys may influence the selection of possible inputs used for pre-computing the Access Stratum security keys.

Similarly, a communication device may be provided for pre-computing one or more keys in anticipation of using a subset of such keys for communications over a network. The communication device may include a communication interface (e.g., communication device or circuit) coupled to a processing circuit. The communication interface may be adapted to communicate with a network entity over a communication network. The processing circuit may be adapted to: (a) establish the base key with the network entity upon the occurrence of a triggering event (e.g., receipt of a message from the network entity), (b) pre-compute a plurality of possible keys using a base key and a plurality of possible inputs in anticipation of receiving an indicator from the network entity that identifies a selected input to be used in generating a corresponding selected key, (c) receive an indicator, from the network entity, of the selected input from among the plurality of possible inputs, (d) select a first key among the pre-computed plurality of possible keys as the selected key upon receipt of the indicator, wherein the first key is selected because it was pre-computed using the selected input, and/or (e) utilize the selected key for one or more communications with the network entity. In one example, the processing circuit may be further adapted to: (f) reduce all available possible inputs to a selected plurality of possible inputs; and/or (g) utilize the selected plurality of possible inputs to pre-compute the plurality of possible keys. Reducing all available possible inputs to a selected plurality of possible inputs may include selecting the most probable inputs based on a history of previously selected inputs. During the pre-computation of the plurality of possible keys, the selected input may be unknown to the communication device. The plurality of possible inputs may include an algorithm with which to calculate security keys.

In one example, the pre-computed plurality of possible keys may be limited by the number of security keys that can be calculated during a time interval between sending an uplink message and receiving a downlink message for the security activation exchange.

According to another feature, the processing circuit is further adapted to predicatively select the plurality of possible inputs from a finite set of inputs, known to the communication device, based on which inputs are most likely to be received from the network entity.

In one example, the communication device may be performing a security activation exchange with the network entity to acquire service via a wireless network. For instance, the security activation exchange may be used to generate the first key which is a key within an Enhanced Universal Mobile Telecommunications Service (UMTS) Terrestrial Radio Access Network (E-UTRAN) key hierarchy. The plurality of possible keys may include Non-Access Stratum security keys and Access Stratum security keys used by Long Term Evolution compatible networks.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates an exemplary network operating environment in which a communication device may implement a reduced-time bearer setup procedure.

FIG. 2 is a diagram illustrating the operation of a communication device adapted to dynamically pre-compute a plurality of possible keys in anticipation of using just a subset of the pre-computed plurality of possible keys.

FIG. 3 is a block diagram illustrating an exemplary communication device that may be configured to pre-compute a plurality of keys in anticipation of at least one of said keys being subsequently employed with a network entity.

FIG. 4 is a flow diagram illustrating a method for pre-computing a plurality of keys in anticipation that at least one of the pre-computed keys will be used.

FIG. 5 illustrates a typical Enhanced UMTS Terrestrial Radio Access Network (E-UTRAN) key hierarchy that may be implemented within a typical LTE network.

FIG. 6 illustrates an exemplary protocol stack that may be implemented in a communication device operating in a LTE packet-switched network.

FIG. 7 illustrates the timeline for security configuration during a typical connection setup/bearer setup between a communication device and a network entity.

FIG. 8 illustrates a timeline for security configuration during an improved connection setup/bearer setup between a communication device and a network entity.

FIG. 9 is a block diagram of an exemplary communication device that may be adapted to perform pre-computation of security keys during bearer setup within an LTE compatible network.

FIG. 10 illustrates a method operational in a communication device to reduce bearer setup time.

FIG. 11 is a block diagram illustrating a network system in which the various security keys illustrated in FIGS. 5 and 6 may be generated.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order avoid obscuring the embodiments in unnecessary detail. In other instances, well-known circuits, structures and techniques may not be shown in detail in order not to obscure the embodiments.

In the following description, certain terminology is used to describe certain features of one or more embodiments. The term “access node” may include base stations, Node-B devices, femto cells, pico cells, etc. The term “communication device” refers to wired and/or wireless subscriber devices, user equipment, mobile phones, pagers, wireless modems, personal digital assistants (PDAs), personal information managers (PIMs), palmtop computers, laptop computers, and/or other wireless or mobile communication/computing devices which communicate, at least partially, through one or more wireless, wired, cellular, communication, and/or data networks. The term “network entity” may refer to one or more devices that are part of a network and/or perform one or more network functions (e.g., authenticate a user equipment, establish a communication connection with a user equipment, etc.). The term “connection” may refer to a wireless or wired communication link which may occur at lower levels of a protocol stack that includes one or more physical and/or logical channels, radio bearers, slots, etc., which is established between a serving network and a user equipment, assigned to individual user equipment and/or shared by a plurality of user equipment. The terms “session” and/or “communication session” refer to establishment of communications at higher levels of a protocol stack in comparison to a connection which occurs at lower levels of a protocol stack.

### Overview

A first feature provides for dynamically computing one or more keys in a communication device in anticipation of using a subset of such keys for communications over a network. The one or more keys are generated during operation of the communication device, not pre-computed by the device manufacturer, service provider, or network, and stored in communication device (e.g., when the communication device is in an active or standby mode). A subset of the generated one or more keys may be subsequently selected for use by the communication device based on subsequent selection by the serving network. In one example, this dynamic pre-computation of keys may be started after receipt of a base key from the serving network. The selected one or more keys may be used, for example, to expedite bearer setup for the communication device.

A second feature provides for pre-computing or deriving one or more security keys during a time interval or period when the communication device anticipates making imminent use of a subset of the one or more security keys with a serving network. For instance, during a registration procedure with the serving network, the communication device may receive a first key from the serving network. The communication device then uses the first key and at least one from a plurality of possible inputs (e.g., security algorithms or functions) to generate a plurality of possible keys. That is, the communication device may iteratively use the first key in combination with another input, from the plurality of possible inputs, to generate the plurality of possible keys. This may be performed during a transmission time interval or an idle period in anticipation of receiving a first input (or identification of the first input) from the serving network, where the first input subsequently identifies at least one of the plurality of possible inputs with which to generate a security key. Consequently, when the communication device receives the first input from the serving network, it merely has to select one of the pre-computed keys from plurality of possible keys.

A third feature provides for intelligently selecting the one or more possible inputs where using the plurality of possible inputs to generate the plurality of possible keys may exceed the available time and/or resources for the communication device to compute all possible keys. For instance, the communication device may utilize the first key and a previously and/or recently used input(s) to generate the one or more possible keys. That is, the communication device may select just a subset of the possible inputs (i.e., based on likely that one such possible input will be selected by the serving network) to thereby compute just a subset of keys that the most likely to be used.

### Exemplary Operating Network Environment

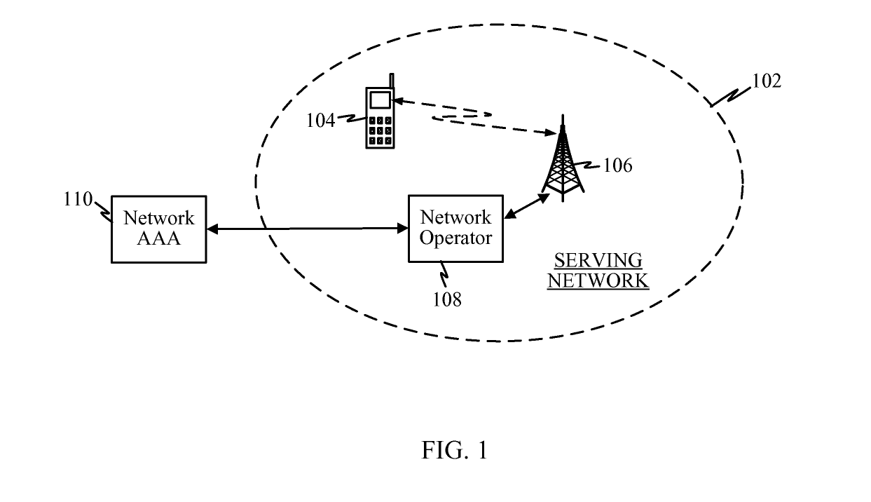

FIG. 1 illustrates an exemplary network operating environment in which a communication device 104 may implement a reduced-time bearer setup procedure. A serving network 102 may include an access node 106 coupled to a network operator controller 108 which is coupled to a network Authentication, Authorization, and Accounting (AAA) 110. The access node 106 may provide one or more communication devices access to the serving network 102 (e.g., a wireless or wired network). For example, a communication device 104 (e.g., mobile device, mobile phone, wireless communication device, access terminal, etc.) may be adapted to setup a communication link (e.g., bearer setup) with the access node 106.

In one exemplary implementation, the serving network 102 may be a public land mobile network (PLMN) that implements a 3GPP Long Term Evolution (LTE) standard. For example, the serving network 102 may include an Evolved/Enhanced Universal Mobile Telecommunications Service (UMTS) Terrestrial Radio Access Network (E-UTRAN), a Mobility Management Entity (MME), a Home Subscriber Server (HSS), and a serving gateway. The E-UTRAN may include a number of evolved Node Bs (eNBs), shown here as access node 106, that support radio communications for one or more communication devices 104. For simplicity, only one access node 106 (e.g., eNB) is shown in FIG. 1. The access node 106 may be a fixed station that communicates with the communication device 104 and may also be referred to as a Node B, a base station, an access point, etc.

At one or more stages of operation, the communication device 104 may be called upon to calculate one or more keys in cooperation or collaboration with the serving network (or another device operating as part of the serving network). Such keys may be used for authentication, registration, and/or security of the communication device 104.

### Exemplary Dynamic Pre-Computation of Keys at Communication Device

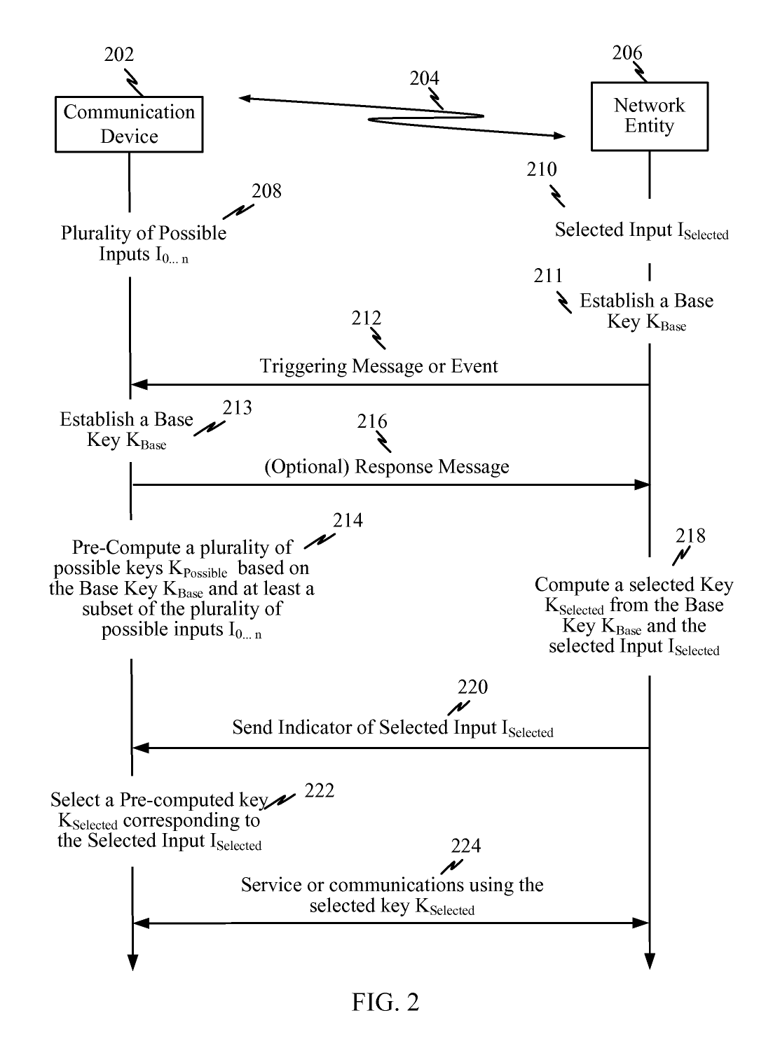

FIG. 2 is a diagram illustrating the operation of a communication device adapted to dynamically pre-compute a plurality of possible keys in anticipation of using just a subset of the pre-computed plurality of possible keys. Here, a communication device 202 may be in communications with a network entity 206 over a serving network 204. The serving network 204 may be a wired and/or wireless network and may include a combination of one or more distinct networks or subnetwork (e.g., a wireless network in combination with a wired network, a visiting network and a home network, etc.). The network entity 206 may be one or more network devices (e.g., access node, mobility manager, AAA (authentication, authorization and accounting) server, etc.).

During various phases of operation, one or more keys may be established between the communication device 208 and one or more network entities. For instance, during device and/or subscriber registration, session establishment, device and/or subscriber authentication, application-level security exchanges, etc., one or more keys may be generated for security and/or other purposes. Here, the communication device 202 may be adapted to pre-compute one or more keys after receiving some indication that a subset of such one or more keys will be used.

Upon the receipt of a triggering message or triggering event 212, the communication device 202 may establish a base key K_{Base} 213. For example, the base key K_{Base} may be a session key, security key, session key, etc., that may be computed based on other keys already known to the communication device 202 and one or more parameters. Such one or more parameters may be received or indicated within the triggering message or event 212. In one example, the base key K_{Base} 213 may be generated based on a “challenge input” received in the triggering message 212. Optionally, a response message 216 may be sent by the communication device 202 in response to the triggering message 212. Note that, in some embodiments, the base key K_{Base} may be known only to the communication device 202 and, possibly, the network entity 206.

Upon receipt of the triggering message or event 212, the communication device 202 may anticipate the subsequent use of one or more possible keys K_{Possible-0 . . . i} that depend (at least partially) on the base key K_{Base}. If the one or more possible keys K_{Possible-0 . . . i} are finite in number, then the communication device 202 may be able to pre-compute the plurality of possible keys K_{Possible-0 . . . i} before they are needed. The plurality of possible keys K_{Possible-0 . . . i} may be based on the base key K_{Base} and at least a subset of a plurality of possible inputs I_{0 . . . n} 208 which may be known to the communication device 202. The plurality of possible inputs I_{0 . . . n} 208 may be algorithms, numbers, etc. The network entity 206 may similarly known at least one selected input I_{Selected} 210 within the plurality of possible inputs I_{0 . . . n} 208. For example, the plurality of possible inputs I_{0 . . . n} 208 and selected input I_{Selected} 210 may be pre-stored in the communication device 202 and network entity 206.

Thus, the communication device 202 may pre-compute a plurality of possible keys K_{Possible-0 . . . i} based on the base key K_{Base} and at least a subset of the plurality of possible inputs I_{0 . . . n} 214 (e.g., possible keys K_{Possible-0 . . . i}=f(K_{Base}, I_{0 . . . i})). The communication device 202 may attempt to dynamically pre-calculate the plurality of possible keys K_{Possible-0 . . . i} prior to actually needing to use one of the plurality of possible keys K_{Possible-0 . . . i}. Depending on the number of possible inputs I_{0 . . . n} 208 and available time in which to calculate the possible keys K_{Possible-0 . . . i}, the communication device 202 may seek to calculate all possible keys or intelligently calculate just a subset of the possible keys. For example, the communication device 202 may seek to calculate the plurality of possible keys K_{Possible-0 . . . i} (or subset thereof) in between the reception of a first message (e.g., the triggering message 212) and an expected subsequent second message that may identify a selected input to be used in the calculating a selected key. If the time period between reception of the first and second message is too short to calculate all possible keys, then the communication device may seek to calculate only the most likely keys. Such selection of the most likely keys may be based on prior experience or most recently used inputs (e.g., the last two or three inputs used in calculating the most recent keys). Note that in some instances, the communication device 202 may pre-compute the plurality of possible keys K_{Possible-0 . . . i} while it is in a standby mode.

Note that the network entity 206 may also have generated or obtained the base key K_{Base} 211 and also knows a selected input I_{Selected} 210 within the plurality of possible keys K_{Possible-0 . . . i}. The network entity 206 is thus able to compute a selected key K_{selected} using the base key K_{Base} and the selected input I_{Selected} 218.

At a subsequent time, the network entity 206 may send an indicator of the selected input I_{Selected} 220 to the communication device 202. Upon receipt of such indicator 220, the communication device 202 may select a pre-computed key, from within the plurality of possible keys K_{Possible-0 . . . i}, corresponding to the selected input i_{Selected} 222. The selected key K_{Selected} may then be used, for example, to secure and/or authenticate services and/or communications 224 between the communication device 202 and/or 206.

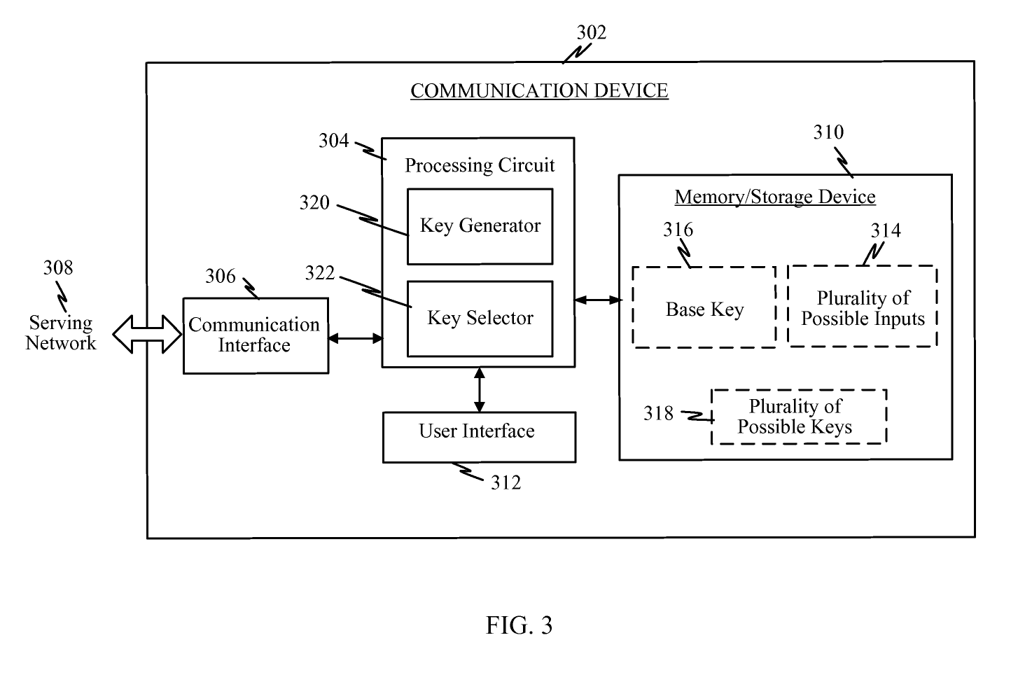

FIG. 3 is a block diagram illustrating an exemplary communication device that may be configured to pre-compute a plurality of keys in anticipation of at least one of said keys being subsequently employed with a network entity. The communication device 302 may include a processing circuit 304 coupled to a communication interface 306, a memory/storage device 310 and/or a user interface 312. The communication interface 306 may serve to couple the communication device 302 to one or more other devices over a serving network 308 (e.g., wired and/or wireless network). The user interface 312 may include input interfaces, such as a keypad, keyboard, touch screen, microphone, camera, etc., and/or output interfaces, such as a speaker, a display screen, etc. The memory/storage device 310 may be a volatile or non-volatile device and serves to store information, such as a base key K_{Base} 316, a plurality of possible inputs I_{0 . . . n} 314, and/or a plurality of possible keys K_{Possible-0 . . . n} 318. The processing circuit 304 may be adapted with a key generator 320 and a key selector 322.

The processing circuit 304 may receive the base key 316, or compute the base key 316 based on a triggering message (e.g., received over the communication interface 306) or an external triggering event (e.g., an indicator from another network device). In one example, the base key 316 may be dynamically generated during operation and is not known beforehand. Upon obtaining or generating the base key 316, the key generator 320 may be adapted to pre-compute a plurality of possible keys based on the base key 316 and the plurality of the possible inputs 314. For example, the key generator 320 may combine the base key 316 and a single possible input (from the plurality of possible inputs 314) to generate a first possible key; this process is repeated for other possible inputs. Note that the possible input may be another key, a specified function or algorithm to use in generating the possible key. The plurality of possible keys 318 may thus be generated in anticipation of using at least one of the possible keys. If the plurality of possible keys 318 can be calculated quickly enough, the can be calculated prior to actually needing to use one of the possible keys, thereby reducing latency. That is, by pre-computing the plurality of possible keys prior to obtaining the input needed to identify the key to be used, the overall time delays or latency can be reduced.

If the number of possible keys is too numerous to compute in the available amount of time (e.g., between obtaining the base key and obtaining a specific input from the serving network used to generate a subsequent key), then the key generator 320 may select a subset of the plurality of possible inputs 314 with which to calculate the plurality of possible keys 318. For instance, the key generator 320 may select the two or three most recently used inputs to calculate the plurality of possible keys 318. In one example, the plurality of possible inputs 314 may include a plurality of security functions which use the base key 316 as a parameter. Thus, if the communication device 302 is operating in the same general region, the serving network for that region likely uses the same security function. Thus, there is a high likelihood that the input that is subsequently received will be one of the most recently used inputs (e.g., functions).

Once a selected input is received by the communication device 302 from the serving network 308, the key selector 322 identifies which of the plurality of possible keys 318 was generated using the received selected input and selects the corresponding key. The selected key may then be used by the communication device 302 to secure a communication, transmission, service, and/or authentication over the communication interface 306.

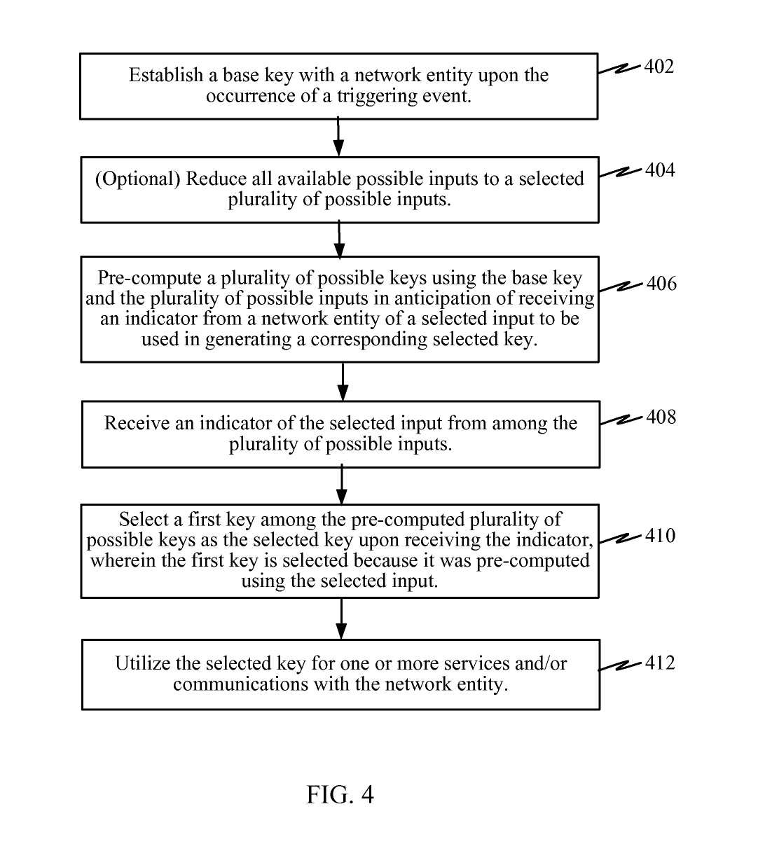

FIG. 4 is a flow diagram illustrating a method for pre-computing a plurality of keys in anticipation that at least one of the pre-computed keys will be used. That is, in order to shorten or reduce delays in providing communications and/or services to a user, the communication device may pre-compute the plurality of keys knowing that at least one said key will be needed in providing subsequent communications and/or services. For example, such triggering event may be the receipt of a challenge message during a registration procedure with the network entity. This method may be implemented by various types of communication devices including, for example, the communication devices illustrated in FIGS. 1, 2, and/or 3.

A base key may initially be established with a network entity upon the occurrence of a triggering event 402.

Optionally, the communication device may intelligently reduce all available inputs to a selected (subset) plurality of possible inputs 404. That is, where the available inputs is too numerous to compute all corresponding keys within a given/available time period, the communication device may select just a reduced set of possible inputs. For instance, the reduced set (e.g., plurality) of possible inputs may be the most probable inputs to be used/selected by the network entity (e.g., based on a history of previously selected inputs).

A plurality of possible keys are then pre-computed by the communication device by using the base key and the plurality of possible inputs in anticipation of receiving an indicator from a network entity of a selected input to be used in generating a corresponding selected key 406. The plurality of possible keys may be associated with a specific or particular service or communication. The communication device may store these keys until at least one said key is needed. Subsequently, the communication device may receive an indicator of the selected input from among the plurality of possible inputs 408. Such indicator may be a message from the network entity indicating or identifying a particular input. In one example the particular selected input is one of the plurality of possible inputs already known to the communication device. Upon receiving the indicator, the communication device may select a first key among the pre-computed plurality of possible keys as the selected key, where the first key is selected because it was pre-computed using the selected input 410. That is, a key that was pre-computed using the same selected input as identified by the indicator, is chosen as the selected key. The communication device may then utilize the selected key for one or more services and/or communications with the network entity 412. For example, the selected key may be used for security and/or authentication purposes. This process of pre-computation of keys may be performed for various types of keys and at various layers of a communication stack for the communication device in order to reduce the latency and/or delay that may be experienced by a user.

### Exemplary Reduction of Bearer Setup Time in LTE Networks

In one exemplary implementation, the method of FIG. 4 may be implemented in the reduction of bearer setup time in a Long Term Evolution (LTE) network (e.g., during a security activation exchange).

A radio link (e.g., radio bearer) is initially setup between an access node (e.g., providing access to a network) and a communication device. A session bearer (e.g., logical bearer or logical channel) may then be established over the radio link and one or more services and/or communications may be established over the session bearer. The session bearer and/or services/communications may be secured by one or more security keys.

As part of the session bearer setup, an authentication request, and/or one or more key exchanges may take place. In networks operating according to an LTE-compatible protocol, such one or more keys may be derived by the communication device based on one of two algorithms, where the algorithm is provided by the network (or one or more network entities) in each exchange.

Consequently, one feature provides for the communication device to calculate or derive all possible security keys during the bearer setup time, i.e., the time while the communication device is waiting for a bearer setup response or message from the network (or a network entity).

### Exemplary E-UTRAN Key Hierarchy

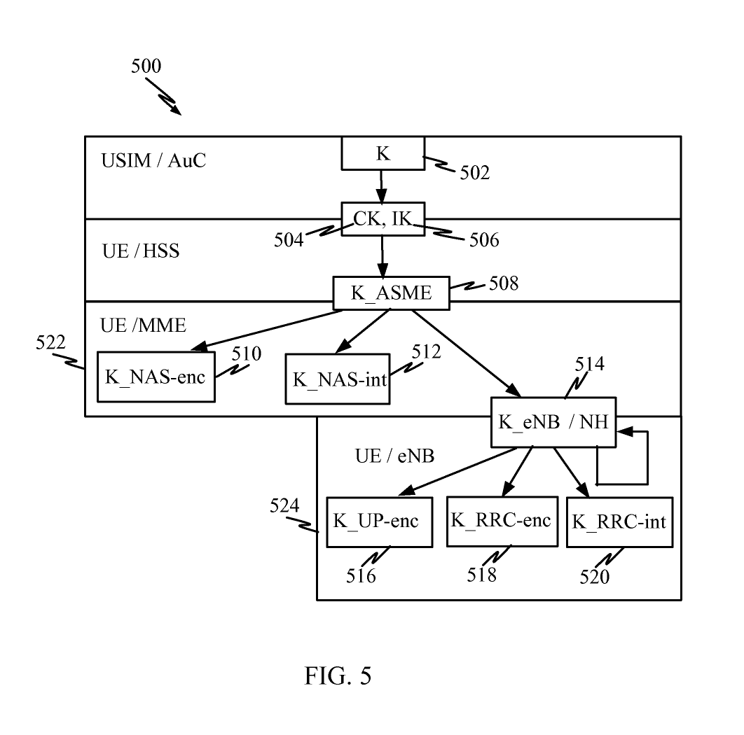

FIG. 5 illustrates a typical Enhanced UMTS Terrestrial Radio Access Network (E-UTRAN) key hierarchy 500 that may be implemented within a typical LTE network. Here, a Universal Subscriber Identity Module (USIM), in the communication device (e.g., mobile device or user equipment (UE)), and an Authentication Center (AuC) (e.g., part of the network entity), at the network side, use a master key K 502 to generate a cipher key (CK) 504 and integrity key (IK) 506. The cipher key (CK) 504 and integrity key (IK) 506 may then be used by the communication device and a Home Subscriber Server (HSS) (e.g., part of the network entity), at the network side, to generate an Access Security Management Entity key K_ASME 508. The security activation of a communication device operating in an LTE network may be accomplished through an Authentication and Key Agreement procedure (AKA), Non-Access Stratum (NAS) Security Mode Configuration (NAS SMC) and Access Stratum (AS) Security mode Configuration (AS SMC). AKA is used to derive the key K_ASME 508, which is then used as a base key for the calculation of NAS (Non-Access Stratum) keys 510 and 512 and AS (Access Stratum) keys 514, 516, 518, and 520. The communication device and a Mobility Management Entity (MME) (e.g., part of the network entity), at the network side, may then use the K_ASME 508 to generate one or more of these security keys.

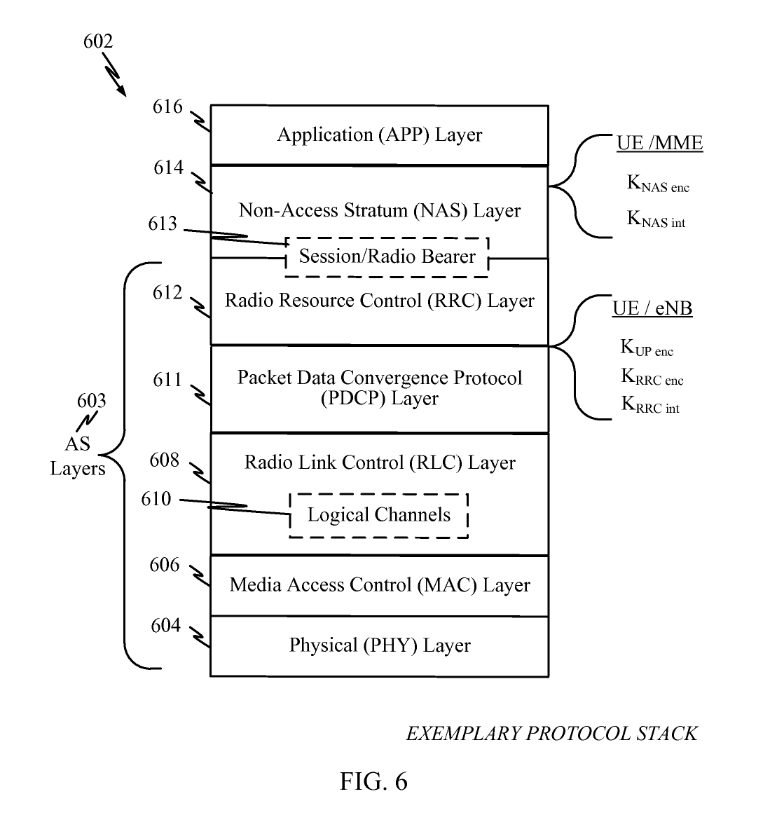

LTE packet-switched networks may be structured in multiple hierarchical protocol layers, where the lower protocol layers provide services to the upper layers and each layer is responsible for different tasks. For example, FIG. 6 illustrates an exemplary protocol stack that may be implemented in a communication device operating in a LTE packet-switched network. In this example, the LTE protocol stack 602 includes a Physical (PHY) Layer 604, a Media Access Control (MAC) Layer 606, a Radio Link Control (RLC) Layer 608, a Packet Data Convergence Protocol (PDCP) Layer 611, a Radio Resource Control (RRC) Layer 612, a Non-Access Stratum (NAS) Layer 614, and an Application (APP) Layer 616. The layers below the NAS Layer 614 are often referred to as the Access Stratum (AS) Layer 603. The RLC Layer 608 may include one or more channels 610. The RRC Layer 612 may implement various monitoring modes for the user equipment, including connected state and idle state. The Non-Access Stratum (NAS) Layer 614 may maintain the communication device's mobility management context, packet data context and/or its IP addresses. Note that other layers may be present in the protocol stack 602 (e.g., above, below, and/or in between the illustrated layers), but have been omitted for the purpose of illustration. Radio/session bearers 613 may be established, for example at the RRC Layer 612 and/or NAS Layer 614. Consequently, the NAS Layer 614 may be used by the communication device (i.e., user equipment (UE)) and a mobility management entity (MME) (i.e., part of the network entity) to generate the security keys K_NAS-enc 510 and K_NAS-int 512. Similarly, the RRC Layer 612 may be used by the communication device (i.e., user equipment (UE)) and an eNB (enhanced Node B) (e.g., access node that is part of the network entity) to generate the security keys K_UP-enc 516, K_RRC-enc 518, and K_RRC-int 520. While the security keys K_UP-enc 516, K_RRC-enc 518, and K_RRC-int 520 may be generated at the RRC Layer 612, these keys may be used by the PDCP Layer 611 to secure signalling and/or user/data communications. For instance, the key K_UP-enc 516 may be used by the PDCP Layer 611 to secure for user/data plane (UP) communications, while the keys K_RRC-enc 518, and K_RRC-int 520 may be used to secure signalling (i.e., control) communications at the PDCP Layer 611.

In one example, prior to establishing these security keys (keys K_NAS-enc 510, K_NAS-int 512, K_UP-enc 516, K_RRC-enc 518, and/or K_RRC-int 520), communications to/from a communication device may be transmitted (unprotected or unencrypted) over an unsecured common control channel (CCCH). After these security keys are established, these same user data and/or control/signaling communications may be transmitted over a Dedicated Control Channel (DCCH).

During the connection setup/session bearer setup procedures in an LTE-compatible network, AKA and NAS SMC procedures are optional if there is an existing native NAS security context already present from the previous setup sessions. The existing NAS context is just re-used at the time of Service Request, Attach Request and Tracking Area Update (TAU) Request.

According to one feature, the communication device may pre-compute some of the security keys illustrated in FIG. 5 in order to reduce security configuration delay in certain scenarios and hence reduce the radio/session bearer setup time. In the derivation of these security keys, used for ciphering and integrity algorithms, both at the AS (User plane and RRC) and NAS requires that an individual algorithm identity be provided as one of the inputs. At the NAS level (e.g., NAS Layer 614), this is provided to the communication device (UE) by the access node (eNB) in NAS Security Mode Command during the NAS SMC procedure. At the AS level, the algorithms to be used are provided by the Radio Resource Control (RRC) Security Mode Command. Key generation may be done with a key derivation function (KDF), such as the HMAC-SHA-256 function. This is a computationally intensive cryptographic operation. The algorithm key generation for Access Stratum (AS ciphering keys K_UP-enc 516 and K_RRC-enc 518 and integrity key K_RRC-int 520 and for the NAS ciphering key K_NAS-enc 510 and integrity key K_NAS-int 512 (when AKA procedure takes place) adds to the connection/bearer setup time. In generating the NAS security keys K_NAS-enc 510 and integrity key K_NAS-int 512 and RRC security keys K_UP-enc 516, K_RRC-enc 518, and integrity key K_RRC-int 520, the key derivation function KDF takes several types of inputs, including an input algorithm identity provided by the network during a security activation exchange. For instance, the input algorithm identity may identify either Advanced Encryption Standard (AES) or SNOW-3G.

It should be noted that, in some implementations, all security keys (e.g., NAS ciphering and integrity keys and RRC ciphering and integrity keys) are generated using the same key derivation function (KDF), e.g., HMAC-SHA-256, that uses a root/base key (e.g., K_ASME), one or more fixed inputs, and one of the plurality of possible input algorithm identities (i.e., security key=KDF(root/base key, fixed input(s), algorithm identity)).

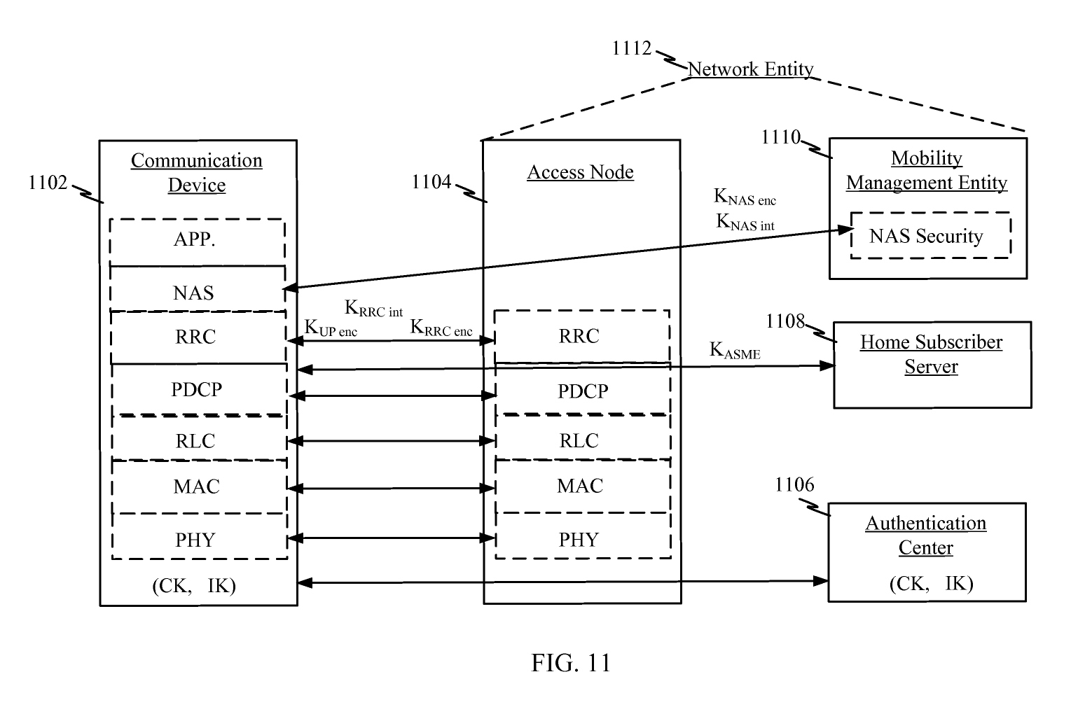

FIG. 11 is a block diagram illustrating a network system in which the various security keys illustrated in FIGS. 5 and 6 may be generated. Here, a communication device 1102 may implement a communication stack that includes various layers (e.g., APP, NAS, RRC, RLC, MAC, and PHY). An access node 1104 may provide wireless connectivity to the communication device 1102 so that it may communicate via serving network. An authentication center (AuC) 1106 and the communication device 1102 may both know or have access to a root key (K) which can be used to generate or obtain a cipher key (CK) and/or an integrity key (IK). The communication device 1102 and/or a home subscriber server (HSS) 1108 may then use at least of the cipher key (CK) and/or integrity key (IK) to generate an Access Security Management Entity key K_ASME. Using the K_ASME key, the communication device 1102 and a mobility management entity (MME) 1110 may then generate the keys K_NAS-enc and K_NAS-int. The communication device 1102 and MME 1110 may also generate an access node-specific key K_eNB/NH. Using this access node specific key K_eNB/NH, the communication device 1102 and access node 1104 may generate the keys K_UP-enc and K_RRC-enc and K_RRC-int.

The access node 1104, MME 1110, HSS 1108, and/or AuC 1106 may be collectively referred to as a network entity 1112.

Details about the derivation of these keys is provided in the 3GPP STD-T63-33.401 “System Architecture Evolution (SAE): Security Architecture” (known as 3GPP TS 33.401) Release 8, which is incorporated herein by reference.

### Exemplary Prior Art Activation Procedure in LTE Networks

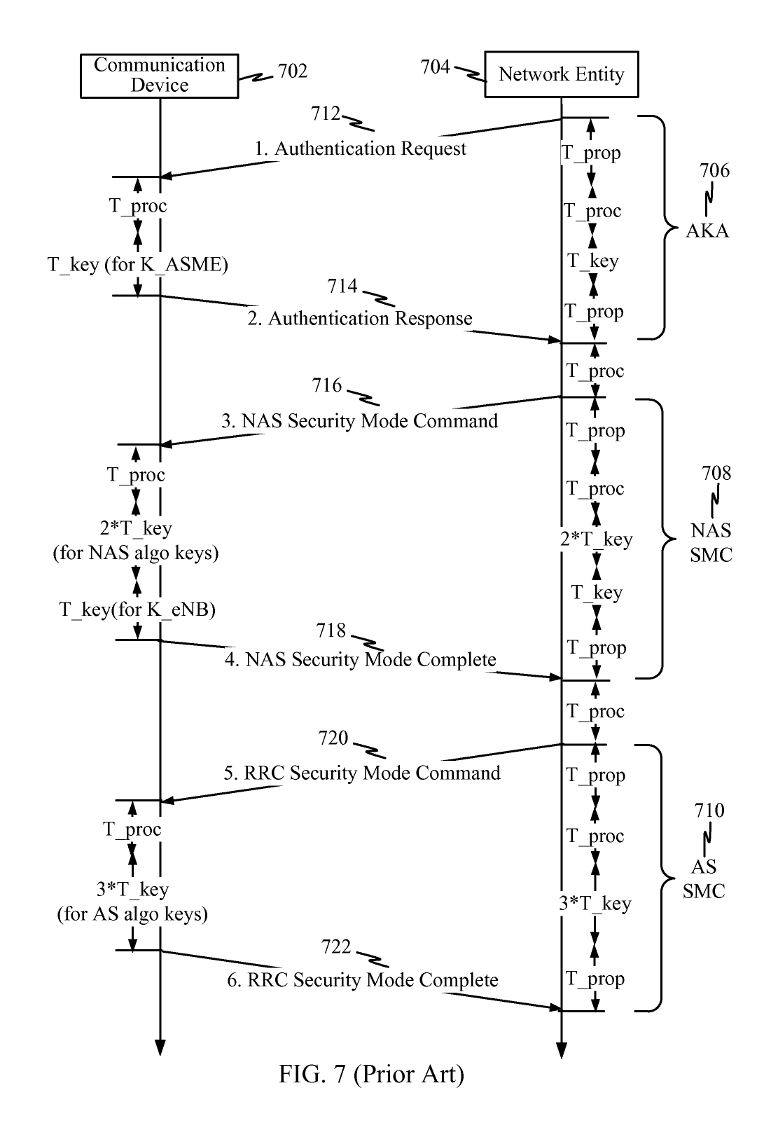

FIG. 7 illustrates the timeline for security configuration during a typical connection setup/bearer setup between a communication device 702 and a network entity 704. It should be clear that, in some implementations, the network entity 704 may represent one or more different network devices, such as an access node, a mobility management entity (MME), a home subscriber server (HSS), an authentication center (AuC), among other network devices. A particular security key may be established between the communication device 702 and one or more these components of the network entity 704. Here, an Authentication and Key Agreement (AKA) procedure 706, a Non-Access Stratum (NAS) Security Mode Command (SMC) procedure 708, and an Access Stratum (AS) Security Mode Command (SMC) procedure 710 may be performed between the communication device 702 and the network entity 704 as part of a bearer setup (e.g., a session/radio bearer setup). It should be noted that the AKA process 706 and NAS SMC process 708 may be optional if there is a NAS security context already present. In such a circumstance, step 718 in FIG. 7 would correspond to an Attach Request/Service Request or Tracking Area Update (TAU) Request. These schemes of ciphering and integrity key computations after the NAS SMC process 708 or AS SMC process 710 may be referred to as post-computation schemes.

For the sake of analysis, a nominal processing time (T_proc) is assumed to be the same for a message at the communication device 702 or the network entity 704. Also, it is assumed that the propagation time for an over-the-air (OTA) message is T_prop while the computation time for a single key computation is T_key.

Here it can be appreciated that the AKA procedure 706 comprises an authentication request 712 and an authentication response 714. The authentication request 712 may trigger the communication device 702 to generate a root or base key K_ASME. The authentication response 714 may be used by the network entity 704 to authenticate the communication device 704 and launch additional steps for security activation.

For instance, the network entity 704 may then initiate the NAS SMC procedure 708 which comprises a NAS Security Mode Command 716 and a NAS Security Mode Complete message 718. The NAS Security Mode Command 716 may trigger the communication device 702 to generate the NAS ciphering key K_NAS-enc 510 and integrity key K_NAS-int 512, both keys based at least partially on the base key K_ASME. This adds a computational delay of 2*T_key to the bearer setup time. Hence the algorithm key computation delay in NAS post-computation scheme is:

T_NAS-post=2*T_key (Equation 1).

Note that the key K_eNB is also generated at this point. The NAS Security Mode Complete message 718 may be sent to the network entity 704 to indicate that these keys have been generated.

During the AS SMC procedure 710, an RRC Security Mode Command 720 is sent by the network entity 704 to the communication device 702. Upon receipt of this message 720, the communication device 702 computes two AS ciphering keys K_RRC-enc 518 and K_UP-enc 516 and one AS integrity key K_RRC-int 520, both keys based at least partially on the key K_eNB 514 or indirectly on the base key K_ASME 508. Hence the algorithm key computation delay in AS post-computation scheme is:

T_AS-post=3*T_key (Equation 2).

Consequently, this adds a computational delay of 3*T_key to the bearer setup time. The communication device 702 may then send an RRC Security Mode Complete message 722 to the network entity to indicate completion of this procedure.

Note that the three key generation procedures 706, 708, and 710 may be undertaken between the communication device 702 and a plurality of different components within the network entity 704.

If the complete AKA procedure 706 and NAS SMC procedure 708 take place, the algorithm key generation delay sums up to a delay of 5*T_key which adds to the bearer setup time.

### Reduction in Bearer Setup Time

In order to improve the key generation latency or delay noted in the prior art approach of FIG. 7, a pre-computation mechanism is provided here to reduce the bearer setup time. While the examples illustrated here refer to an LTE network, these pre-computation mechanisms may be applied in other types of networks. In general, a communication device may pre-compute or derive a plurality of security keys based on a finite number of possible inputs. This pre-computation may be performed after a base key has been computed but before the network entity has provided the selected input to be used. Thus, the communication device makes use of the time in which it typically waits for the selected input to compute a plurality of possible keys based on a plurality of possible inputs. Once the selected input or indication of the selected input is received from the network entity, the communication device merely selects the corresponding pre-computed key from the plurality of possible keys. That is, the pre-computed key that is based on the selected input is selected. In the case of bearer setup for an LTE compliant network, the finite number of inputs may be algorithm identities and one such algorithm identity is selected by the network entity and identified to the communication device.

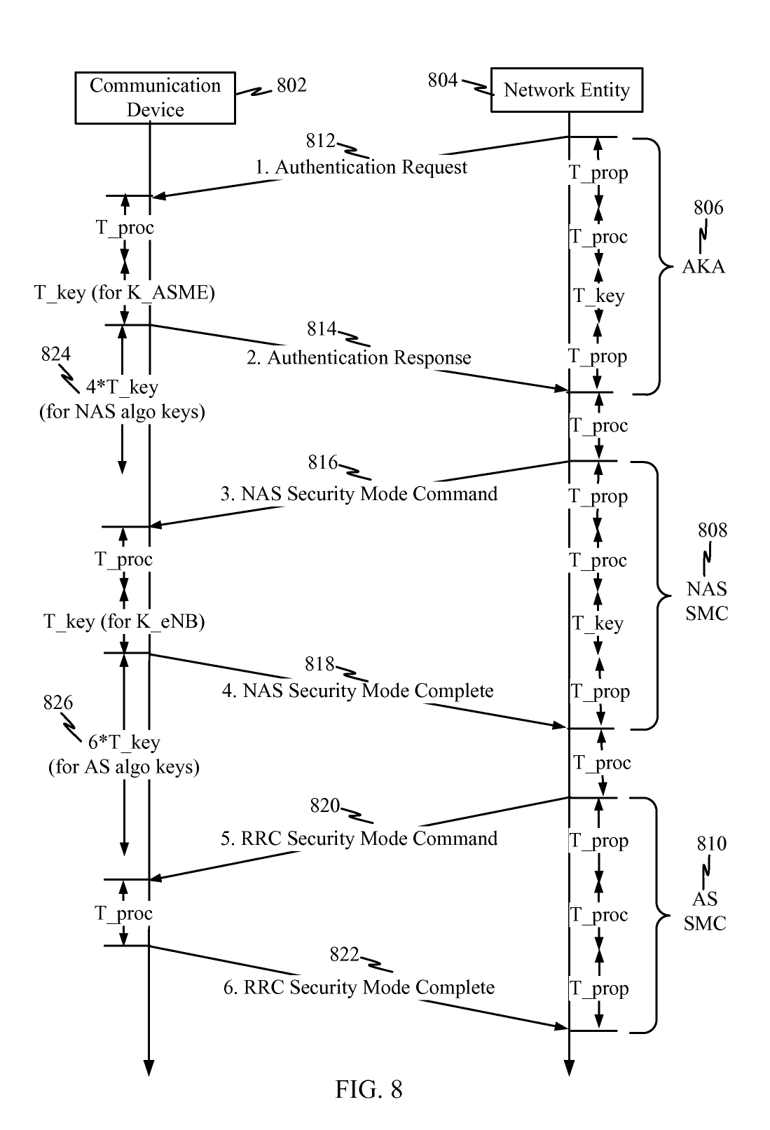

FIG. 8 illustrates a timeline for security configuration during an improved connection setup/bearer setup between a communication device 802 and a network entity 804. Here, an Authentication and Key Agreement (AKA) procedure 806, a Non-Access Stratum (NAS) Security Mode Command (SMC) procedure 808, and an Access Stratum (AS) Security Mode Command (SMC) procedure 810 may be performed between the communication device 802 and the network entity 804 as part of a bearer setup (e.g., a session/radio bearer setup). It should be noted that the AKA process 806 and NAS SMC process 808 may be optional if there is a NAS security context already present.

Here it can be appreciated that the AKA procedure 806 comprises an authentication request 812 and an authentication response 814. The authentication request 812 may trigger the communication device 802 to generate a root or base key K_ASME. The authentication response 814 may be used by the network entity 804 to authenticate the communication device 802 and launch additional steps for security activation.

NAS Algorithm Key Pre-Computation

In the Non-Access Stratum (NAS) Security Mode Command (SMC) procedure 808, the ciphering and integrity algorithms are provided to the communication device 802 by the network entity 804 via the NAS Security Mode Command 816. Along with the base key K_ASME, these algorithm identities are used as inputs to the ciphering key (K_NAS-enc) and integrity key (K_NAS-int) computations.

In the Non-Access Stratum (NAS) algorithm, the key pre-computation mechanism may include pre-computing all security keys using all possible algorithms (e.g., AES and SNOW-3G), so as to reduce bearer setup time. For example, the communication device 802 may pre-compute the NAS integrity key (K_NAS-int) and NAS ciphering key (K_NAS-enc) for each of the algorithm identities (e.g., AES and SNOW-3G), right after the transmission of Authentication Response 814 (Step 2) to the network entity 804. Consequently, the communication device 802 pre-computes four keys 824 in this case (i.e., two K_NAS-int keys and two K_NAS-int keys). In this example, the four NAS ciphering and integrity keys are computed right after the transmission of Authentication Response 814, but prior to the reception of NAS Security Mode Command 816 from the network entity 804. Because the NAS algorithm keys K_NAS-int and K_NAS-enc are pre-computed, there is no additional delay added to the security/bearer configuration delay. In fact, due to this pre-computation, the time between the NAS Security Mode Command 816 and the NAS Security Mode Complete 818 is reduced relative to the prior art approach of FIG. 7. As can be appreciated from FIG. 8, the four keys 824 may be computed during the propagation and processing delays that occur for the round-trip exchange between the communication device 802 and network entity 804, such that:

4*T_key<2*T_prop+T_proc, or (Equation 3)

T_key<(2*T_prop+T_proc)/4. (Equation 4)

On the other hand, if T_key>(2*T_prop+T_proc)/4, there is a non-zero delay due to the algorithm key computations in the NAS pre-computation scheme. It can be seen by analysis that the delay due to algorithm key computation in the NAS pre-computation scheme is:

T_NAS-pre=(4*T_key−2*T_prop−T_proc)*u(4*T_key−2*T_prop−T_proc) (Equation 5)

where u(t) is the step function defined as

u(t)=1 for t>=0

u(t)=0 for t<0.

From Equation 1 and Equation 5, the NAS pre-computation scheme has a smaller delay than the NAS post-computation scheme if

T_NAS-pre<T_NAS-post. (Equation 6)

That is,

(4*T_key−2*T_prop−T_proc)*u(4*T_key−2*T_prop−T_proc)<2*T_key (Equation 7)

or

T_key<(2*T_prop+T_proc)/2. (Equation 8)

Hence, the NAS algorithm key pre-computation (FIG. 8) outperforms post-computation (FIG. 7) when Equation 8 is satisfied.

In yet other implementations, even if just one key (i.e., a first key), from among a plurality of possible keys, is pre-calculated, this would lead to time savings if that first key is ultimately used as the selected security key. For example, it may be assumed that the same input algorithm identity used in previous calculations will also be used on the next security key calculation. Thus, just a single security key may be calculated using the previously used input algorithm identity. This technique may also be expanded to utilize a history of input algorithm identities, only the most commonly used one or two input algorithm identities (from a greater number of input algorithm identities) may be used to perform pre-computation of the security keys. This probabilistic approach may ultimately save processing time by focusing on pre-computing just the most likely security key(s) given an earlier history of input algorithm identities.

Thus, if there is only enough time to pre-compute one security key, if that one security key is ultimately used or selected then this provides a time saving over a post-computation approach (e.g., prior art approach of FIG. 7). In one implementation, the communication device 802 may assume that the previously chosen input algorithm identity will be re-used by the network entity 804.

In yet another example, there may be just enough time to calculate two NAS integrity keys (i.e., one integrity key for each of the two possible input algorithm identities). In this example, a time savings is achieved by pre-calculation of the two possible NAS integrity keys as one of the two possible NAS integrity keys will ultimately be used. The corresponding NAS ciphering key K_NAS_enc may be calculated after the reception of the NAS Security Mode Command 816. Thus, the pre-computation may be partial or full (e.g., as many keys as possible may be pre-calculated during the available time interval while the communication device 802 waits for a downlink message). Thus, the communication device 802 may pre-calculate the NAS keys, the K_eNB key, and the AS keys either partially or completely during one or more a waiting time intervals. Any keys not calculated during the waiting time intervals may be post-computed after a downlink message has been received but before the next uplink message is sent.

In some implementations, all security keys (e.g., NAS ciphering and integrity keys and RRC ciphering and integrity keys) may be generated using the same key derivation function (KDF), e.g., HMAC-SHA-256, that takes a root/base key, one or more fixed inputs, and one of the plurality of possible input algorithm identities (i.e., security key=KDF(root/base key, fixed input(s), algorithm identity)). In yet other implementations, a limited number of key derivation functions may be possible. Thus, the communication device may pre-compute the security keys using all or some of the possible key derivation functions (e.g., KDF1, KDF2 . . . ).

AS Algorithm Key Pre-Computation

Similarly, in the case of Access Stratum (AS) Security Mode Command (SMC) procedure 810, the network entity 804 (e.g., an access node (eNB)) notifies the communication device 802 of which AS level ciphering and integrity algorithms to be used via the RRC Security Mode Command 820. These algorithm identities may then be used as inputs in the computation of three keys—integrity key (K_RRC-int) and ciphering keys (K_RRC-enc and K_UP-enc).

The communication device 802 may pre-compute the three algorithm keys (i.e., K_RRC-int, K_RRC-enc and K_UP-enc) for each algorithm identity (e.g., AES and SNOW-3G) right at the event of (re)activation of NAS integrity and ciphering, i.e., after the transmission of NAS Security Mode Complete 818 (Step 4) in the case when a NAS SMC procedure 808 has taken place or after the transmission of an Attach Request, a Service Request, or a TAU Request in the case when NAS security context already exists. In the AS pre-computation scheme, the six keys (one set of three keys for each of the two algorithms) are computed.

FIG. 8 illustrates the case in which the six AS ciphering and integrity keys are computed right after the transmission of NAS Security Mode Complete 818 message (or equivalently Attach Request, Service Request, or TAU Request), but prior to the reception of the RRC Security Mode Command 820 from the network entity 804 (e.g., eNB or access node). In this case, there is no additional delay due to AS algorithm key generation that is added to the security/bearer configuration delay. This happens when:

6*T_key<2*T_prop+T_proc, (Equation 9)

or Tkey<(2*Tprop+Tproc)/6. (Equation 10)

If T_key>(2*T_prop+T_proc)/6, there is a non-zero delay due to the algorithm key computations in the AS pre-computation scheme.

It can be seen by analysis that the delay due to algorithm key computation in the AS pre-computation scheme 826 is:

T_AS-pre=(6*T_key−2*T_prop−T_proc)*u(6*T_key−2*T_prop−T_proc) (Equation 11),

where u(t) is the step function defined as

u(t)=1 for t>=0

u(t)=0 for t<0.

From Equation 1 and Equation 11, the AS algorithm key pre-computation scheme 826 has a lesser delay than the AS post-computation scheme if

T_AS-pre<T_AS-post. (Equation 12)

That is

(6*T_key−2*T_prop−T_proc)*u(6*T_key−2*T_prop−T_proc)<3*T_key, (Equation 13)

or

T_key<(2*T_prop+T_proc)/3. (Equation 14)

Hence, the AS algorithm key pre-computation outperforms post-computation if when condition Equation 14 is satisfied.

The concept of pre-computation of security keys during bearer setup may be implemented in any communication system where a manageable number of inputs are used to generate the security keys. That is, if the number of possible security keys is very large (e.g., as when the network entity 804 provides the communication device 802 a random number to generate the security keys), pre-computing all possible security keys during the short time window (e.g., between when the communication device 802 send a response and when it receives a subsequent (next) message/command) may not be feasible. Therefore, this pre-computation mechanism is best applicable when a manageable finite number of inputs are possible given the available time window and processing resources. Alternatively, even if a very large number of inputs are possible, the pre-computation mechanism may be implemented when only a few of those inputs are highly probable. Thus, security keys may be pre-calculated using just the most likely (probable) inputs. Consequently, due to probability, some or all of the pre-calculated keys will be used, thereby saving time.

As noted above, even if only some of the possible keys are pre-calculated, time will be saved if at least one of those keys is subsequently used.

Exemplary Communication Device with Reduced Bearer Setup Time

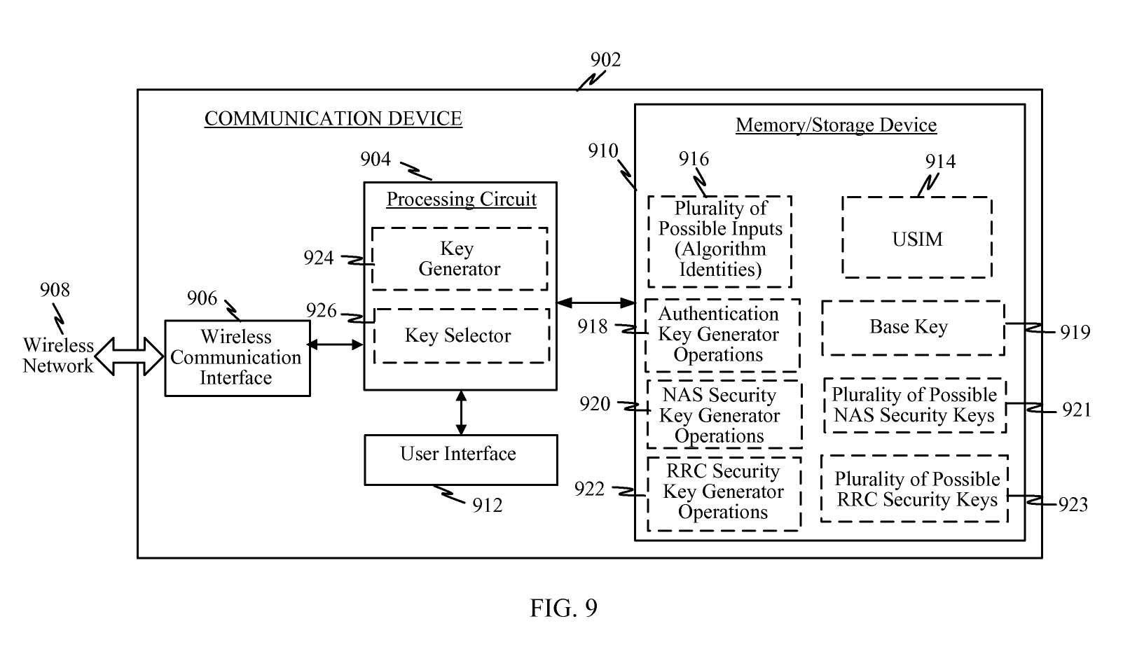

FIG. 9 is a block diagram of an exemplary communication device 902 that may be adapted to perform pre-computation of security keys during bearer setup within an LTE compatible network. The communication device 902 may include a processing circuit 904 coupled to a wireless communication interface 906, a user interface 912, and/or a memory/storage device 910. The wireless communication interface 906 may enable the communication device 902 to wirelessly communicate via a wireless network 908 with and access node and/or other network entities. The user interface 912 may include, for example, a microphone, speaker, a display screen, and/or a keypad. The memory/storage device 910 may include one or more modules to implement operation of the communication device 902, including authentication and/or security procedures with a serving network, as well as data structure for the storage of various keys. In some implementations, the processing circuit 904 may be a purpose-specific processor (e.g., control plane protocol processing unit, ARM processor, etc.) for generating keys during bearer setup, while in other implementation the processing circuit may be a general purpose processor. For instance, the processing circuit 904 may include a key generator 924 adapted to perform one or more of the key generation operations defined in an authentication key generator 918, a NAS security key generator 920, and/or a RRC security key generator 922.

In one example, a universal subscriber identification module (USIM) 914 may be adapted to store a root key which may be used to obtain cipher key (CK) and/or an integrity key (IK). These cipher and/or integrity key(s) may then be used by the key generator 924 (implementing authentication key generator operations 918) to generate an Access Security Management Entity key K_{ASME}. The Access Security Management Entity key K_{ASME} may be stored in the memory/storage device as a base key 919. After sending an Authentication Response 814 (FIG. 8), the communication device 902 may expect a NAS Security Mode Command 816 (FIG. 8) identifying an algorithm to be used in generating NAS security keys. However, rather than waiting for the NAS Security Mode Command 816 (FIG. 8), the communication device 902 uses the key generator 924 (implementing NAS Security Key Generator operations 920) to generate all possible NAS security keys (e.g., K_NAS-int and K_NAS-enc) and stores the pre-computed NAS security keys 921 in the memory/storage device 910. Because the communication device 902 has all possible algorithms that may be identified and there are only a few such algorithms (e.g., two or three algorithms—AES and SNOW-3G), the processing circuit 904 (or other specialized processor in the communication device) may pre-compute all possible NAS security keys (e.g., using all possible algorithms). This security key computation may be performed after sending the Authentication Response 814 (FIG. 8) and before receiving the NAS Security Mode Command 816 (FIG. 8) which identifies the algorithm to be used. Upon receiving the NAS Security Mode Command 816 (FIG. 8), which identifies the algorithm to be used in calculating NAS security keys, a key selector 926 in the processing circuit 904 merely selects the NAS security key (corresponding to the identified algorithm) from the pre-computed plurality of possible NAS security keys 921. The communication device 902 then sends a NAS Security Mode Complete message 818 (FIG. 8).

Upon sending the NAS Security Mode Complete message 818 (FIG. 8), the communication device 902 expects an RRC Security Mode Command 820 (FIG. 8) identifying the algorithm to be used in generating RRC security keys. However, rather than waiting for the RRC Security Mode Command 820, the key generator 924 (implementing RRC Security Key Generator operations 922) to generate all possible RRC security keys (e.g., K_RRC-int, K_RRC-enc and K_UP-enc) using all possible algorithms (e.g., Advanced Encryption Standard (AES) and SNOW-3G) and stores the pre-computed RRC security keys 923 in the memory/storage device 910. Because the communication device 902 has all possible algorithms (i.e., plurality of possible inputs 916) that may be identified and there are only a few such algorithms (e.g., two or three algorithms), the processing circuit 904 (or other specialized processor in the communication device) may compute all possible RRC security keys (e.g., using all possible algorithms). This security key computation may be performed after sending the NAS Security Mode Complete message 818 and before receiving the RRC Security Mode Command 820 which identifies the algorithm to be used. Upon receiving the RRC Security Mode Command 820 (FIG. 8), which identifies the algorithm to be used in calculating AS security keys, the key selector 926 in the processing circuit 904 merely selects the RRC security key (corresponding to the identified algorithm) from the pre-computed plurality of possible RRC security keys 922. The communication device 902 then sends an RRC Security Mode Complete message 822 (FIG. 8).

Note that, in some implementations, the communication device 902 may pre-compute as many keys as possible (and as early as possible) in the bearer setup process. For instance, after sending the Authentication Response 814 but before receiving the NAS Security Mode Command 816 (which identifies the selected input or algorithm), the key generator 924 may generate as many of the NAS security keys and/or RRC security keys as possible. For instance, the processing circuit 904 may estimate the round trip time in which it may expect the NAS Security Mode Command 816, and may calculate the NAS security keys (e.g., K_NAS-int and K_NAS-enc) and some or all of the RRC security keys (e.g., K_RRC-int, K_RRC-enc and K_UP-enc).

Note that one advantage of pre-calculating all or a plurality of the possible security keys is that, if the network decides to change the security algorithm while a call or session is established, then the communication device can simply use one of the pre-computed keys. Thus, the pre-computed plurality of possible security keys 921 and 923 may be stored (even after a security key has been selected) in the memory/storage device 910. Note that the pre-computed keys 921 and 923 may be based, directly or indirectly, on the base key 919 (e.g., Access Security Management Entity key K_{ASME}) that is obtained using on over the air authentication process with the network (or network entity).

According to yet another aspect, the processing circuit 904, key generator 924, and/or key generator operations 920 and/or 922 may be adapted to predicatively select the plurality of possible inputs from a finite set of inputs, known to the communication device 902, based on which inputs are most likely to be received from the network entity. For instance, all available possible inputs may be reduced to a selected plurality of possible inputs, and the selected plurality of possible inputs may be utilized to pre-compute the plurality of possible keys. That is, a record or log of the most recently used inputs (e.g., for the previous n security activation exchanges) may be maintained by the processing circuit 904 and/or memory/storage device 910. This record or log may be used in deciding which inputs should be used first and/or which inputs should be preferred or selected as the plurality of possible inputs. For instance, the most recently used inputs may be selected first or preferred or the most probable inputs may be selected based on a history of previously selected inputs.

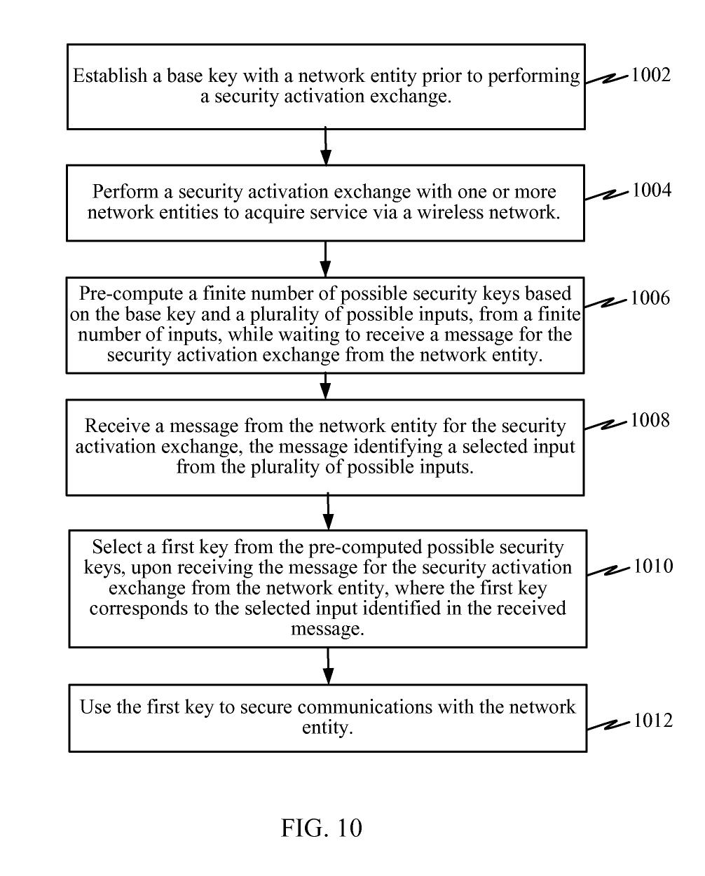

FIG. 10 illustrates a method operational in a communication device to reduce bearer setup time (e.g., within an LTE-compatible network). In one example, the communication device 902 in FIG. 9 (and/or components therein) may implement one or more of the steps, functions, and/or operations of this method. A base key may be established with a network entity prior to performing a security activation exchange 1002. A security activation exchange may be performed with one or more network entities to acquire service via a wireless network 1004. The security activation exchange message may identify one of a plurality (e.g., two, three, four, etc.) of possible algorithms to be used in generating the security keys. A finite number of possible security keys may be pre-computed based on the base key and a plurality of possible inputs (e.g., input algorithm identities), from a finite number of (known) inputs, while waiting to receive a message for the security activation exchange from the network entity 1006. In pre-computing the finite number of possible security keys, the particular input (e.g., input algorithm identity) to be used at a particular stage of the security activation exchange is unknown to the communication device. The communication device may subsequently receive a message from the network entity for the security activation exchange, the message identifying a selected input from the plurality of possible inputs 1008. Upon receiving the message for the security activation exchange from the network entity, the communication device may select a first key, from the pre-computed possible security keys, corresponding to the selected input identified in the received message 1010. That is, the selected first key is selected because it was previously generated based on the selected input. The first key may then be used for securing communications between the communication device and network entity 1012.

In one example, the security activation exchange may generate keys within the Enhanced UMTS Terrestrial Radio Access Network (E-UTRAN) key hierarchy. The wireless network may be compatible with a Long Term Evolution communication standard. The finite number of security keys may include Non-Access Stratum security keys and Access Stratum security keys. The finite number of security keys may be generated in a time interval between when the communication device sends a message to the network and a time when it receives the message for the security activation exchange. The finite number of security keys may be computed in imminent expectation that at least one or more of the security keys will be subsequently utilized in the security activation exchange. The finite number of security keys may include a first set of two security keys for Non-Access Stratum security and a second set of three keys for Access Stratum security.

While several of the examples described herein refer to input algorithm identities used in the generation of security keys, it should be understood that the concepts described herein extend to any input, from a set of finite inputs, which may be used to generate a key. That is, between the time that the communication device sends an uplink message and the time it receives a downlink message, the communication device may pre-compute a plurality of keys using a plurality of possible inputs (from a set of finite inputs or combination of inputs) so as to reduce delays associated with generating keys on the fly or in real-time. So long as the number of possible input combinations is manageable (e.g., given the time and/or processing resources available), then the pre-computation may reduce the time in which the communication device sends a subsequent response.

One or more of the components, steps, features and/or functions illustrated in the FIGS. may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the FIGS. may be configured to perform one or more of the methods, features, or steps described in the FIGS. The novel algorithms described herein may also be efficiently implemented in software and/or embedded in hardware.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational in a communication device, comprising:
pre-computing a plurality of possible keys using a base key and a plurality of possible inputs in anticipation of receiving an indicator from a network entity that identifies a selected input to be used in generating a corresponding selected key;
receiving an indicator, from the network entity, of the selected input from among the plurality of possible inputs; and
selecting a first key among the pre-computed plurality of possible keys as the selected key upon receipt of the indicator, wherein the first key is selected because it was pre-computed using the selected input.

2. The method of claim 1, further comprising:
establishing the base key with the network entity upon the occurrence of a triggering event.

3. The method of claim 2, wherein the triggering event is receipt of a message from the network entity.

4. The method of claim 1, further comprising:
utilizing the selected key for one or more communications with the network entity.

5. The method of claim 1, further comprising:
reducing all available possible inputs to a selected plurality of possible inputs; and
utilizing the selected plurality of possible inputs to pre-compute the plurality of possible keys.

6. The method of claim 5, wherein reducing all available possible inputs to a selected plurality of possible inputs includes
selecting the most probable inputs based on a history of previously selected inputs.

7. The method of claim 1, further comprising:
performing a security activation exchange with the network entity to acquire service via a wireless network.

8. The method of claim 7, wherein the security activation exchange is used to generate the first key which is a key within an Enhanced Universal Mobile Telecommunications Service (UMTS) Terrestrial Radio Access Network (E-UTRAN) key hierarchy.

9. The method of claim 1, wherein the pre-computed plurality of possible keys are limited by the number of security keys that can be calculated during a time interval between sending an uplink message and receiving a downlink message for the security activation exchange.

10. The method of claim 1, wherein the plurality of possible keys includes Non-Access Stratum security keys and Access Stratum security keys used by Long Term Evolution compatible networks.

11. The method of claim 1, further comprising:
predicatively selecting the plurality of possible inputs from a finite set of inputs, known to the communication device, based on which inputs are most likely to be received from the network entity.

12. The method of claim 11, wherein a plurality of possible inputs selected for pre-computing the Non-Access Stratum security keys influence the selection of possible inputs used for pre-computing the Access Stratum security keys.

13. The method of claim 1, wherein during the pre-computation of the plurality of possible keys, the selected input is unknown to the communication device.

14. The method of claim 1, wherein the plurality of possible inputs includes algorithms with which to calculate security keys.

15. A communication device comprising:
a communication interface for communicating with a network entity over a communication network;
a processing circuit coupled to the communication interface, the processing circuit adapted to:
pre-compute a plurality of possible keys using a base key and a plurality of possible inputs in anticipation of receiving an indicator from the network entity that identifies a selected input to be used in generating a corresponding selected key;
receive an indicator, from the network entity, of the selected input from among the plurality of possible inputs; and
select a first key among the pre-computed plurality of possible keys as the selected key upon receipt of the indicator, wherein the first key is selected because it was pre-computed using the selected input.

16. The communication device of claim 15, wherein the processing circuit is further adapted to:
establish the base key with the network entity upon the occurrence of a triggering event.

17. The communication device of claim 16, wherein the triggering event is receipt of a message from the network entity.

18. The communication device of claim 15, wherein the processing circuit is further adapted to:
utilize the selected key for one or more communications with the network entity.

19. The communication device of claim 15, wherein the processing circuit is further adapted to:
reduce all available possible inputs to a selected plurality of possible inputs; and
utilize the selected plurality of possible inputs to pre-compute the plurality of possible keys.

20. The communication device of claim 19, wherein reducing all available possible inputs to a selected plurality of possible inputs includes
selecting the most probable inputs based on a history of previously selected inputs.

21. The communication device of claim 15, wherein the pre-computed plurality of possible keys are limited by the number of security keys that can be calculated during a time interval between sending an uplink message and receiving a downlink message for the security activation exchange.

22. The communication device of claim 15, wherein the processing circuit is further adapted to:
predicatively select the plurality of possible inputs from a finite set of inputs, known to the communication device, based on which inputs are most likely to be received from the network entity.

23. The communication device of claim 15, wherein during the pre-computation of the plurality of possible keys, the selected input is unknown to the communication device.

24. The communication device of claim 15, wherein the plurality of possible inputs includes algorithm with which to calculate security keys.

25. The communication device of claim 15, wherein the processing circuit is further adapted to:
perform a security activation exchange with the network entity to acquire service via a wireless network.

26. The communication device of claim 15, wherein the security activation exchange is used to generate the first key which is a key within an Enhanced Universal Mobile Telecommunications Service (UMTS) Terrestrial Radio Access Network (E-UTRAN) key hierarchy.

27. The communication device of claim 15, wherein the plurality of possible keys includes Non-Access Stratum security keys and Access Stratum security keys used by Long Term Evolution compatible networks.

28. A communication device comprising:
means for pre-computing a plurality of possible keys using a base key and a plurality of possible inputs in anticipation of receiving an indicator from a network entity that identifies a selected input to be used in generating a corresponding selected key;
means for receiving an indicator, from the network entity, of the selected input from among the plurality of possible inputs; and
means for selecting a first key among the pre-computed plurality of possible keys as the selected key upon receipt of the indicator, wherein the first key is selected because it was pre-computed using the selected input.

29. The communication device of claim 28, further comprising:
means for establishing the base key with the network entity upon the occurrence of a triggering event.

30. The communication device of claim 28, further comprising:
means for utilizing the selected key for one or more communications with the network entity.

31. The communication device of claim 28, further comprising:
means for predicatively selecting the plurality of possible inputs from a finite set of inputs, known to the communication device, based on which inputs are most likely to be received from the network entity.

32. A processor-readable medium having one or more instructions operational in a communication device, which when executed by one or more processors causes the processors to:
pre-compute a plurality of possible keys using a base key and a plurality of possible inputs in anticipation of receiving an indicator from a network entity that identifies a selected input to be used in generating a corresponding selected key;
receive an indicator, from the network entity, of the selected input from among the plurality of possible inputs; and
select a first key among the pre-computed plurality of possible keys as the selected key upon receipt of the indicator, wherein the first key is selected because it was pre-computed using the selected input.

33. The processor-readable medium of claim 32, further comprising one or more instructions which when executed by the one or more processors causes the processors to:
establish the base key with the network entity upon the occurrence of a triggering event.

34. The processor-readable medium of claim 32, further comprising one or more instructions which when executed by the one or more processors causes the processors to:
reduce all available possible inputs to a selected plurality of possible inputs; and
utilize the selected plurality of possible inputs to pre-compute the plurality of possible keys.

35. The processor-readable medium of claim 32, further comprising one or more instructions which when executed by the one or more processors causes the processors to:
predicatively select the plurality of possible inputs from a finite set of inputs, known to the communication device, based on which inputs are most likely to be received from the network entity.
